(19) United States
(12) Patent Application Publication
(10) Pub. No.: US 2025/0223861 A1
(43) Pub. Date: Jul. 10, 2025

(54) METHOD FOR OPERATING A MOTORISED FLAP ARRANGEMENT

(71) Applicant: BROSE FAHRZEUGTEILE SE & CO. KOMMANDITGESELLSCHAFT, BAMBERG, Bamberg (DE)

(72) Inventors: Christopher Trenkle, Bamberg (DE); Dominic Liebermann, Ebersdorf (DE); Wolfgang Uebel, Weitramsdorf (DE); Sebastian Hermeling, Bamberg (DE); Johannes Schulz, Reckendorf (DE)

(21) Appl. No.: 18/688,174

(22) PCT Filed: Aug. 29, 2022
(86) PCT No.: PCT/EP2022/073890

§ 371 Date: Oct. 14, 2024

(30) Foreign Application Priority Data
Sep. 3, 2021 (DE) 10 2021 122 903.0

(51) Int. Cl. E05F 15/73

(52) U.S. Cl. CPC E05F 15/73; E05Y 2400/858; E05Y 2900/531

(57) ABSTRACT

Method for operating a flap arrangement of a vehicle. A control arrangement for activating a drive arrangement assigned to the flap arrangement and a distance sensor coupled to the control arrangement are provided. Sensor values relating to actions of people outside the motor vehicle are detected by the distance sensor. The detected sensor values are checked by the control arrangement for the fulfillment of predetermined operator action criteria. An approach criterion is predetermined, which relates to the observance of a predetermined approach movement of the detected person into a predetermined detection region. A gesture criterion is predetermined, which relates to the observance of a predetermined relative movement of a body part of the detected person relative to the rest of the person in a predetermined triggering region. The fulfillment of the approach criterion and gesture criterion is defined as a prerequisite for at least one of the valid operator actions.

### CROSS-REFERENCE TO RELATED APPLICATIONS

This application is a national stage application under 35 U.S.C. 371 of International Patent Application Serial No. PCT/EP2022/073890, entitled “Method for Operating a Motorised Flap Arrangement,” filed Aug. 29, 2022, which claims priority from German Patent Application No. DE 10 2021 122 903.0, filed Sep. 3, 2021, the disclosures of which are incorporated herein by reference.

### FIELD OF THE TECHNOLOGY

Various embodiments relate a method for operating a motorized flap arrangement, to a control arrangement for a motorized flap arrangement, and to a flap arrangement for a motor vehicle.

### BACKGROUND

In the known method (JP 2010-236184 A), on which some embodiments are based, the operation of the flap is intended via a predefined operator action, which is defined by an operator gesture such as a hand movement. In order to reduce the likelihood of an erroneous activation by passers-by, one operator action criterion is to check whether the operator is already present in a detection region for a minimum residence time. When a hand movement is subsequently detected, the motorized adjustment of the flap arrangement is triggered and is used, for example, to open the flap.

### SUMMARY

It is a challenge to further reduce the likelihood of erroneous triggering. Especially under confined conditions, when a plurality of objects and people in the region of the flap arrangement are simultaneously detected by sensor, random movements may lead to a triggering of the motorized adjustment.

The problem underlying some embodiments is to design and develop the method in such a way that the likelihood of an erroneous activation is kept low even in the case of operator gestures that are simple to carry out.

The above problem is solved by various features described herein.

The flap arrangement in question is provided for a flap adjustable by motor. The flap may be any closure element of a motor vehicle. These include tailgates, rear covers, front hoods, in particular engine hoods, doors, in particular side doors or rear doors, or the like. The flap may be arranged pivotably or longitudinally displaceably on the motor vehicle body.

It can be essential in some cases to take into account, in addition to gesture recognition, the fundamental consideration as to whether the operator is approaching the vehicle with an actuation intention, which can be assessed here on the basis of the detected approach movement of a person. In addition, the gesture is specifically recognized with reference to a relative movement of one body part relative to the rest of the person. Overall, erroneous triggering, for example by people already in the detection region or by random movements, can thereby be largely avoided.

Specifically, it is proposed that, as one of the operator action criteria, an approach criterion is predetermined, which relates to the observance of a predetermined approach movement of the detected person into a predetermined detection region, that, as one of the operator action criteria, a gesture criterion is predetermined, which relates to the observance of a predetermined relative movement of a body part of the detected person relative to the rest of the person in a predetermined triggering region, and that the fulfillment of the approach criterion and gesture criterion is defined as a necessary prerequisite for at least one of the valid operator actions.

Various embodiments relate to the relative movement of the body part, which movement is monitored with the gesture criterion. With reference to the determination of a person reference position and a body part displacement present for this purpose, the gesture can be characterized in a particularly reliable manner and in particular it can be taken into account whether the relative movement originates from the actual person or whether it is a random movement.

In addition, the determination of the person reference position with reference to a cluster model for targets detected in the sensor values is provided in some embodiments, wherein this embodiment is used in particular for radar targets. The person reference position can therefore be obtained easily, for example by means of a geometric averaging.

In some embodiments, a classification of targets as a body part for the recognition of the relative movement is carried out. Here too it is highly reliably avoided that random movements of objects are incorrectly classified as operator gestures.

A flap reference position according to some embodiments can in particular serve as a reference for the approach movement of the operator and the relative movement of the gesture. In particular, the gesture recognition is thereby improved, wherein a conscious operator gesture with actuation intention is carried out, for example, in the direction of the flap reference position.

Also in order to avoid erroneous triggering, according to various embodiments an additional person recognition criterion can be provided and therefore, for example, a distinction can be made between persons and other objects. In various embodiments, the person recognition criterion is based in turn on a classification of the detected object, which is the subject matter of some embodiments.

In various embodiments, with the checking of a determined person trajectory, it is possible with a high degree of reliability to distinguish, for example, between a targeted approach of the operator to the flap arrangement with an operating intent and a random passing of a person.

In various embodiments, a synchronization between the operator gesture and the motorized adjustment is provided, specifically in such a way that, when the body part reaches a flap reference position, the motorized adjustment has already been triggered, has already progressed or has already been completed. This makes it possible to avoid waiting times which have to be accepted by the operator until the motorized adjustment is complete.

According to various embodiments, a control arrangement for a flap arrangement of a motor vehicle is provided. The control arrangement is responsible here for checking the predetermined operator action criteria and for activating the drive arrangement. Reference is made to all of the statements regarding the proposed method.

According to various embodiments, a flap arrangement for a motor vehicle is provided, which is designed for carrying out the proposed method. Reference is also made in this respect to all of the statements regarding the proposed method.

Various embodiments provide a method for operating a motorized flap arrangement of a motor vehicle, wherein a control arrangement for activating a motorized drive arrangement assigned to the flap arrangement and a distance sensor coupled to the control arrangement are provided, wherein sensor values relating to actions of people outside the motor vehicle are detected by means of the distance sensor, wherein the detected sensor values are checked by means of the control arrangement for the fulfillment of predetermined operator action criteria, wherein actions detected via the sensor values are rejected or qualified as a valid operator action, depending on the result of the check, and wherein, upon detection of a valid operator action, the drive arrangement is activated by means of the control arrangement for the motorized adjustment of the flap arrangement, wherein, as one of the operator action criteria, an approach criterion is predetermined, which relates to the observance of a predetermined approach movement of the detected person into a predetermined detection region, wherein, as one of the operator action criteria, a gesture criterion is predetermined, which relates to the observance of a predetermined relative movement of a body part of the detected person relative to the rest of the person in a predetermined triggering region, and wherein the fulfillment of the approach criterion and gesture criterion is defined as a necessary prerequisite for at least one of the valid operator actions.

In various embodiments, in the checking of the gesture criterion from the sensor values, a person reference position of the detected person and a deflection of the body part of the detected person relative to the person reference position are determined. In various embodiments, the gesture criterion relates to the observance of a predetermined movement pattern by the deflection. In various embodiments, the gesture criterion relates to the observance of a predetermined movement path, a predetermined movement velocity, a predetermined movement velocity course, a predetermined movement acceleration and/or a predetermined movement acceleration course.

In various embodiments, a plurality of targets detected in the sensor values, in particular radar targets, are assigned to the person and are combined according to a cluster model to form a cluster target for the determination of the person reference position. In various embodiments, the deflection of the body part relative to the person reference position is determined on the basis of a body part reference position of at least one body part target which is assigned to the person and is approaching in the triggering region.

In various embodiments, in the checking of the gesture criterion, targets approaching in the triggering region are classified as body part targets in the sensor values on the basis of the extent and/or the approach movement, in particular the direction of approach and/or approach velocity. In various embodiments, the targets approaching in the triggering region are classified as body part targets on the basis of a main component analysis.

In various embodiments, at least one flap reference position of the flap arrangement is predetermined, wherein, according to the gesture criterion, the predetermined relative movement of the body part substantially runs in the direction of the flap reference position, ends in the region of the flap reference position or brushes over the flap reference position. In various embodiments, the flap reference position is provided on a door handle, a B-pillar or an engagement door edge of the flap arrangement.

In various embodiments, as an operator action criterion, a person recognition criterion is predetermined, which relates to a classification of an object detected via the sensor data as a person, and wherein the fulfillment of the person recognition criterion is defined as a further necessary prerequisite for the at least one of the valid operator actions.

In various embodiments, in the checking of the person recognition criterion, the detected object is classified as a person with reference to the extent and/or the approach movement of the object, in particular the direction of approach and/or approach velocity. In various embodiments, the detected object is classified as a person on the basis of a main component analysis.

In various embodiments, a time-dependent association of detected sensor values to the person is carried out by means of the control arrangement in an operator tracking routine, wherein a person trajectory is determined from the time dependency of the sensor values associated with the person, and wherein the approach criterion relates to the observance of a trajectory specification by the person trajectory.

In various embodiments, the approach criterion relates to a minimum residence time of the object in the detection region, and/or wherein the gesture criterion relates to a minimum residence time of the body part in the triggering region.

In various embodiments, the motorized adjustment is carried out upon detection of the valid operator action in such a way that, with continued relative movement of the body part of the operator, in particular at an unchanged movement velocity, in the direction of the flap reference position, when the body part reaches the flap reference position, the motorized adjustment has already been triggered, has already progressed or has already been completed.

Various embodiments provide a control arrangement for a motorized flap arrangement of a motor vehicle, wherein the control arrangement is provided for activating a motorized drive arrangement associated with the flap arrangement and for coupling to a distance sensor, wherein sensor values regarding actions of people outside the motor vehicle are detected by means of the distance sensor, wherein the control arrangement checks the detected sensor values for the fulfillment of predetermined operator action criteria, wherein, depending on the result of the check, actions detected via the sensor values are rejected or qualified as a valid operator action, and wherein, upon detection of a valid operator action, the control arrangement activates the drive arrangement for the motorized adjustment of the flap arrangement, wherein, as one of the operator action criteria, an approach criterion is predetermined, which relates to the observance of a predetermined approach movement of the detected person into a predetermined detection region, wherein, as one of the operator action criteria, a gesture criterion is predetermined, which relates to the observance of a predetermined relative movement of a body part of the detected person relative to the rest of the person in a predetermined triggering region, and wherein the fulfillment of the approach criterion and gesture criterion is defined as a necessary prerequisite for at least one of the valid operator actions.

Various embodiments provide a flap arrangement for a motor vehicle designed for carrying out the method as described herein.

### BRIEF DESCRIPTION OF THE DRAWINGS

Various aspects are explained in more detail below with reference to a drawing merely illustrating exemplary embodiments. In the drawing

FIG. 1 shows a proposed motor vehicle for carrying out the proposed method in a top view.

### DETAILED DESCRIPTION

The exemplary embodiment shown in the figure relates to a method for operating a motorized flap arrangement 1 of a motor vehicle 2. A control arrangement 3 is used to activate a motorized drive arrangement 4 assigned to the flap arrangement 1.

In the illustrated exemplary embodiment, the drive arrangement 4 is provided for transferring a flap 5 of the flap arrangement 1 from a closed position into an open position. The open position can be the complete open position of the flap 5 or an open position of the flap 5 within the context of a pushing-open operation, which allows the operator access to an engagement door edge for manually opening the flap 5. Transferring the flap 5 from an open position into a closed position can also be provided.

In principle, the drive arrangement 4 can also cause other motorized adjustment functions of the flap arrangement 1, for example, unlocking and/or opening of a motor vehicle lock associated with the flap 5. For possible embodiments of the flap 5, reference is made to the introductory statements, wherein here the flap 5 is shown by way of example as a side door.

A distance sensor 6, which can be designed as a radar sensor, is coupled to the control arrangement 3. The distance sensor 6 may also be based on lidar, ultrasonic sensors, optical sensors, capacitive sensors or the like. Sensor values with respect to actions of people P, P′ outside the motor vehicle 2 are detected by means of the distance sensor 6. The distance sensor 6 may be integrated in an actuating element of the flap 5, such as a door handle 7.

The radar sensor here has an antenna arrangement which can be configured with one or more antenna arrays arranged in particular in a predetermined angular position and position with respect to one another. The radar sensor can implement a continuous, in some embodiments frequency-modulated, distance measurement and direction measurement, for example as an FMCW radar sensor. The radar sensor can be designed for operation with radar radiation in the frequency band around 24 GHz and/or 77 GHz.

The sensor values can be representative of the position of objects outside the motor vehicle 2. For example, the sensor values contain distance information and direction information between the detected object, here the people P, P′, and the motor vehicle 2. In various embodiments, the sensor values also contain velocity information of the object, such as Doppler information determined via the radar sensor.

The detected sensor values are checked by means of the control arrangement 3 for the fulfillment of predetermined operator action criteria, wherein, depending on the result of the check, actions detected via the sensor values are rejected or qualified as a valid operator action. An action should generally be understood here as meaning an act of the person P acting as an operator, in particular a course of movement related to the person P, such as an approach and/or the movement of a body part 8 of the person P. Upon detection of a valid operator action, the drive arrangement 4 is activated by means of the control arrangement 3 for the motorized adjustment of the flap arrangement 1.

In a monitoring run, the sensor values can be checked here by means of the control arrangement 3 for the fulfillment of the operator action criteria. For example, a degree of fulfillment is determined on the basis thereof, wherein the detected action is rejected or qualified as a valid operator action depending on the degree of fulfillment determined. In the first case, no activation of the drive arrangement 4 results. In the second case, the drive arrangement 4 is activated by means of the control arrangement 3. Individual operator action criteria can be defined as sufficient or necessary operator action criteria for the activation. In this case, operator action criteria can also be stored for a plurality of valid operator actions, which in particular also lead to different activations of the drive arrangement 4.

It is now essential that, as one of the operator action criteria, an approach criterion is predetermined, which relates to the observance of a predetermined approach movement A of the detected person P into a predetermined detection region 9, that, as one of the operator action criteria, a gesture criterion is predetermined, which relates to the observance of a predetermined relative movement G of a body part 8 of the detected person P relative to the rest of the person P in a predetermined triggering region 10, and that the fulfillment of the approach criterion and gesture criterion is defined as a necessary prerequisite for at least one of the valid operator actions.

At least one of the valid operator actions therefore requires both a certain type of approach of the person (represented by the approach criterion) and a certain type of operator gesture (represented by the gesture criterion). By combining both criteria as necessary operator action criteria, increased safety against erroneous triggering is achieved. It is conceivable that other valid operator actions that do not require the above criteria are defined.

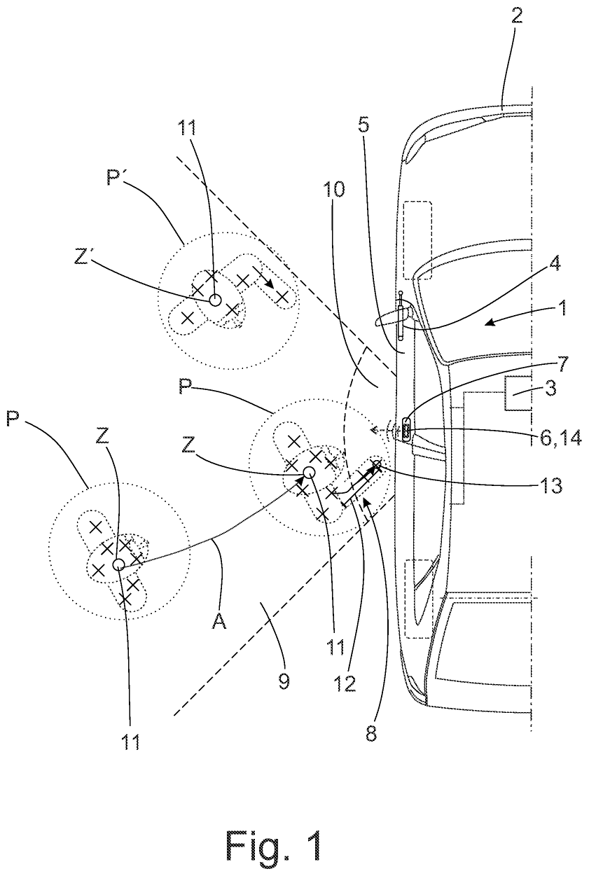

The approach criterion relates to the observance of a predetermined approach movement A, which is representative of an approach of an operator with an actuation intent, and with which the operator moves in the predetermined detection region 9. For example, it is hereby possible to avoid the detection of a person P′ who is moving only slightly in the detection region 9, or else the detection of a static object, leading to a triggering. It is shown by way of example in FIG. 1 that the person P performs an approach movement A and can undertake an actuation with the execution of a gesture G. For the stationary person P′ here in FIG. 1, however, the approach criterion is not fulfilled, and therefore the activation fails to materialize upon the gesture G′.

The detection region 9 is a predetermined region outside the motor vehicle 2, which is at least partially detected by the distance sensor 6 and which is provided for carrying out the approach movement A. For example, it is provided that, in order to meet the approach criterion, the person P approaches within an angular portion in relation to the motor vehicle 2 formed by the detection region 9.

The gesture criterion relates to the observance of a predetermined relative movement of a body part 8 of the detected person P relative to the rest of the person P. When detecting the movement of a body part 8, it is set in relation to the person. For example, a gesture G′ randomly performed near the person P by another person P′ is not classified as a relative movement of a body part 8 of the person P.

The triggering region 10 here is a predetermined region outside the motor vehicle 2, which is at least partially detected by the distance sensor 6 and which is provided for carrying out the operator gesture.

In various embodiments, it is provided that, in the checking of the gesture criterion from the sensor values, a person reference position 11 of the detected person and a deflection 12 of the body part 8 of the detected person P relative to the person reference position 11 is determined.

The deflection 12 can be used, among other things, to determine whether the movement of a detected body part 8 actually originates from the respective person P. This can be determined, for example, by means of a course of movement of the detected body part 8 relative to the person reference position 11. If, for example, the detected body part 8 continuously moves away from an initial position near the person reference position 11 to an end position at a distance from the person reference position 11, the detected course of movement can be classified as valid relative movement. The person reference position 11 can also be used to take into account that the person P as a whole may still continue to move while the operator gesture is being carried out.

In addition, further requirements can be imposed on the operator gesture and can be taken into account in the definition of the gesture criterion. In various embodiments, the gesture criterion relates to the observance of a predetermined movement pattern by the deflection 12. This includes, inter alia, the observance of a predetermined movement path, a predetermined movement velocity, a predetermined movement velocity course, a predetermined movement acceleration and/or a predetermined movement acceleration course.

For example, the movement pattern may be defined in such a way that the movement pattern comprises a swipe movement or a movement back and forth, such as a kick movement. The movement path may be defined by a sequence of absolute positions relative to the motor vehicle body. The movement pattern can be defined relative to the person reference position 11.

Furthermore, in various embodiments, it is provided that a plurality of targets, which are detected in the sensor values, are assigned to the person P, P′ and are combined according to a cluster model to form a cluster target Z for the determination of the person reference position 11.

The cluster model can be based on the determination of a cluster target Z with reference to statistical values. Different statistical functions can be used to determine the statistical values, such as statistical mean values such as a geometric center of gravity, in this case the volume center of gravity, of the radar targets to be assigned to the person P.

In particular, the cluster model is applied to radar targets. The targets to be assigned to the person P can be selected with reference to position values, amplitude values and/or velocity values. The amplitude values, in some embodiments, should be understood as meaning the intensity of the reflected radar waves. In a further embodiment, the targets can be selected with velocity values for the determination of the cluster target Z, for example depending on whether the targets approach the motor vehicle 2 in a predetermined manner, for example at a predetermined minimum velocity.

Further, it can be provided that the deflection 12 of the body part 8 relative to the person reference position 11 is determined on the basis of a body part reference position 13 of at least one body part target which is assigned to the person and is approaching in the triggering region 10.

The distance between the position of the person reference position 11 and the body part reference position 13 can be determined here as the deflection 12. If there are a plurality of body part targets, they can also be combined via a cluster model into a cluster target K in order to obtain the body part reference position 13.

For example, the body part target selected is a target which is to be assigned to the person P and which is closest to a flap reference position 14, and/or the body part target is selected with reference to an approach velocity in the triggering region 10.

It is further provided, in some embodiments, that, in the checking of the gesture criterion, targets approaching in the triggering region 10 are classified as body part targets in the sensor values with reference to the extent and/or the approach movement, in particular the direction of approach and/or approach velocity.

It is, for example, additionally checked via the classification whether the targets are representative of the body part 8 with which the operator gesture is to be performed. For example, only targets with a spatial arrangement that corresponds to the arrangement of a hand, an arm, a foot, or a leg are classified as body part targets. In various embodiments, it is provided that the targets approaching in the triggering region 10 are classified as body part targets on the basis of a main component analysis.

Furthermore, in some embodiments, it is provided that at least one flap reference position 14 of the flap arrangement 1 is predetermined, that, according to the gesture criterion, the predetermined relative movement of the body part 8 runs substantially in the direction of the flap reference position 14, ends in the region of the flap reference position 14 or brushes over the flap reference position 14.

In various embodiments, the relative movement is set here with respect to the person reference position 11 and the flap reference position 14. For example, it may be made possible here for the person P to also be able to perform a valid operator gesture in the direction of the flap reference position 14 with a transverse movement of the body.

In particular, the operator is provided via the flap reference position 14 with a simple orientation possibility of carrying out a valid operator action. The flap reference position 14 may be visually highlighted on the motor vehicle 2, in particular on the flap arrangement 1. In various embodiments, the flap reference position 14 is provided on a door handle 7, a B pillar or an engagement door edge of the flap arrangement 1.

It is further provided, in some embodiments, that, as an operator action criterion, a person recognition criterion is predetermined, which relates to a classification of an object detected via the sensor data as a person P, P′, and that the fulfillment of the person recognition criterion is defined as a further necessary prerequisite for the at least one of the valid operator actions.

The classification is thus used to additionally check whether the objects detected in the sensor values are representative of a person P, P′, such that other objects in the exterior region of the motor vehicle 2 do not lead to erroneous triggering.

It is further provided, in some embodiments, that, in the checking of the person recognition criterion, the detected object is classified as a person P, P′ with reference to the extent and/or the approach movement of the object, in particular the direction of approach and/or approach velocity, such as that the detected object is classified as a person P, P′ on the basis of a main component analysis.

For example, only detected targets are classified as a person P, P′, the distance of which from one another corresponds to the extent of a person P, P′, in particular based on the detected dimensions and spatial shape. This prevents, for example, passing animals from being classified as a person P, P′.

It is further provided, in some embodiments, that a time-dependent association of detected sensor values to the person P, P′ is carried out by means of the control arrangement 3 in an operator tracking routine, that a person trajectory is determined from the time dependency of the sensor values associated with the person P, P′, and that the approach criterion relates to the observance of a trajectory specification by the person trajectory.

The person trajectory represents a path curve with which the operator moves according to the sensor values relative to the motor vehicle 2 and indicates, at least at discrete times, the position of the person P, P′ depending on the time. The position of the operator means here the location of the entire body of the person P, P′, which is given in particular by the respective person reference position 11 and which can be determined on the basis of the already discussed cluster model.

To determine the operator trajectory, a time-dependent association of detected sensor values is made. In this case, targets, such as radar targets, can be identified in the sensor values, in particular with reference to the intensity and in some embodiments with reference to exceeding a predetermined intensity threshold value. Individual targets of said targets are associated with the person P, wherein the course of movement of said targets is determined in a temporal sequence of sensor values.

The trajectory specification is generally representative of person trajectories that correspond to a valid approach toward the motor vehicle 2 by the operator in order to trigger the motorized adjustment. The trajectory specification, in some embodiments, contains at least one position-related specification and at least one time-related specification.

If sensor values for the time-dependent association are temporarily missing, a mathematical estimation model can be used to determine the person trajectory. The estimation model is based in particular on an alpha-beta filter, a Kalman filter and/or a nonlinear filter.

In a further embodiment, it is provided that the approach criterion relates to a minimum residence time of the object in the detection region. In particular, it can thereby be checked in a simple way whether the person performs a stopping movement in the detection region, which in many cases is an indication of an actuation intention.

It may also be provided that the gesture criterion relates to a minimum residence time of the body part 8 in the triggering region 10. This also furthermore ensures that a movement of a body part 8 carried out by the person P is a deliberately executed operator movement.

It is also provided, in some embodiments, that the motorized adjustment is carried out upon detection of the valid operator action in such a way that, with continued relative movement of the body part 8 of the operator, in particular at an unchanged movement velocity, in the direction of the flap reference position 14, when the body part 8 reaches the flap reference position 14, the motorized adjustment has already been triggered, has already progressed or has already been completed.

Here, the flap 5 can already be partially or even completely adjusted when the body part 8 of the operator reaches the flap 5. Therefore, the operator does not have to accept waiting for the completion of a motorized adjustment, in particular a pushing-open operation of the flap 5. It is conceivable that, with the detection of the operator gesture, the movement velocity of the body part 8 of the operator is already determined, and therefore the time at which the body part 8 of the operator is expected to reach the flap 5 can be calculated. The motorized adjustment can be made on the basis of this calculation. In this case, it can be assumed for simplification purposes that the movement velocity of the continued movement of the body part 8 remains unchanged compared to the movement velocity during the operator gesture.

In various embodiments, a control arrangement 3 is provided for a motorized flap arrangement 1 of a motor vehicle 2, wherein the control arrangement 3 is provided for activating a motorized drive arrangement 4 which is assigned to the flap arrangement 1 and for coupling to a distance sensor 6, wherein sensor values relating to actions of people outside the motor vehicle 2 are detected by means of the distance sensor 6, wherein the detected sensor values are checked by means of the control arrangement 3 for the fulfillment of predetermined operator action criteria, wherein actions detected via the sensor values are rejected or qualified as a valid operator action, depending on the result of the check, and wherein, upon detection of a valid operator action, the control arrangement 3 activates the drive arrangement 4 for the motorized adjustment of the flap arrangement 1.

It is essential here that, as one of the operator action criteria, an approach criterion is predetermined, which relates to the observance of a predetermined approach movement of the detected person into a predetermined detection region 9, that, as one of the operator action criteria, a gesture criterion is predetermined, which relates to the observance of a predetermined relative movement of a body part 8 of the detected person relative to the rest of the person in a predetermined triggering region 10, and that the fulfillment of the approach criterion and gesture criterion is defined as a necessary prerequisite for at least one of the valid operator actions. Reference is made to all of the statements regarding the proposed method.

Furthermore, according to various embodiments, a flap arrangement 1 for a motor vehicle 2 is provided, which is designed for carrying out the proposed method. Reference is made to all of the statements regarding the proposed method.

1. A method for operating a motorized flap arrangement of a motor vehicle, wherein a control arrangement for activating a motorized drive arrangement assigned to the flap arrangement and a distance sensor coupled to the control arrangement are provided, wherein sensor values relating to actions of people outside the motor vehicle are detected by the distance sensor, wherein the detected sensor values are checked by the control arrangement for the fulfillment of predetermined operator action criteria, wherein actions detected via the sensor values are rejected or qualified as a valid operator action, depending on the result of the check, and wherein, upon detection of a valid operator action, the drive arrangement is activated by the control arrangement for the motorized adjustment of the flap arrangement, wherein, as one of the operator action criteria, an approach criterion is predetermined, which relates to the observance of a predetermined approach movement of the detected person into a predetermined detection region, wherein, as one of the operator action criteria, a gesture criterion is predetermined, which relates to the observance of a predetermined relative movement of a body part of the detected person relative to the rest of the person in a predetermined triggering region, and wherein the fulfillment of the approach criterion and gesture criterion is defined as a necessary prerequisite for at least one of the valid operator actions.

2. The method as claimed in claim 1, wherein, in the checking of the gesture criterion from the sensor values, a person reference position of the detected person and a deflection of the body part of the detected person relative to the person reference position are determined.

3. The method as claimed in claim 1, wherein a plurality of targets detected in the sensor values are assigned to the person and are combined according to a cluster model to form a cluster target for the determination of the person reference position.

4. The method as claimed in claim 1, wherein, in the checking of the gesture criterion, targets approaching in the triggering region are classified as body part targets in the sensor values on the basis of the extent and/or the approach movement.

5. The method as claimed in claim 1, wherein at least one flap reference position of the flap arrangement is predetermined, wherein, according to the gesture criterion, the predetermined relative movement of the body part substantially runs in the direction of the flap reference position, ends in the region of the flap reference position or brushes over the flap reference position.

6. The method as claimed in claim 1, wherein, as an operator action criterion, a person recognition criterion is predetermined, which relates to a classification of an object detected via the sensor data as a person, and wherein the fulfillment of the person recognition criterion is defined as a further necessary prerequisite for the at least one of the valid operator actions.

7. The method as claimed in claim 1, wherein, in the checking of the person recognition criterion, the detected object is classified as a person with reference to the extent and/or the approach movement of the object.

8. The method as claimed in claim 1, wherein a time-dependent association of detected sensor values to the person is carried out by means of the control arrangement in an operator tracking routine, wherein a person trajectory is determined from the time dependency of the sensor values associated with the person, and wherein the approach criterion relates to the observance of a trajectory specification by the person trajectory.

9. The method as claimed in claim 1, wherein the approach criterion relates to a minimum residence time of the object in the detection region, and/or wherein the gesture criterion relates to a minimum residence time of the body part in the triggering region.

10. The method as claimed in claim 1, wherein the motorized adjustment is carried out upon detection of the valid operator action in such a way that, with continued relative movement of the body part of the operator, in the direction of the flap reference position, when the body part reaches the flap reference position, the motorized adjustment has already been triggered, has already progressed or has already been completed.

11. A control arrangement for a motorized flap arrangement of a motor vehicle, wherein the control arrangement is provided for activating a motorized drive arrangement associated with the flap arrangement and for coupling to a distance sensor, wherein sensor values regarding actions of people outside the motor vehicle are detected by means of the distance sensor, wherein the control arrangement is configured to check the detected sensor values for the fulfillment of predetermined operator action criteria, wherein, depending on the result of the check, actions detected via the sensor values are rejected or qualified as a valid operator action, and wherein, upon detection of a valid operator action, the control arrangement activates the drive arrangement for the motorized adjustment of the flap arrangement, wherein, as one of the operator action criteria, an approach criterion is predetermined, which relates to the observance of a predetermined approach movement of the detected person into a predetermined detection region, wherein, as one of the operator action criteria, a gesture criterion is predetermined, which relates to the observance of a predetermined relative movement of a body part of the detected person relative to the rest of the person in a predetermined triggering region, and wherein the fulfillment of the approach criterion and gesture criterion is defined as a necessary prerequisite for at least one of the valid operator actions.

12. A flap arrangement for a motor vehicle, designed for carrying out the method as claimed in claim 1.

13. The method as claimed in claim 2, wherein the gesture criterion relates to the observance of a predetermined movement pattern by the deflection.

14. The method as claimed in claim 2, wherein the gesture criterion relates to the observance of a predetermined movement path, a predetermined movement velocity, a predetermined movement velocity course, a predetermined movement acceleration and/or a predetermined movement acceleration course.

15. The method as claimed in claim 3, wherein the deflection of the body part relative to the person reference position is determined on the basis of a body part reference position of at least one body part target which is assigned to the person and is approaching in the triggering region.

16. The method as claimed in claim 4, wherein the targets approaching in the triggering region are classified as body part targets on the basis of a main component analysis.

17. The method as claimed in claim 5, wherein the flap reference position is provided on a door handle, a B-pillar or an engagement door edge of the flap arrangement.

18. The method as claimed in claim 7, wherein the detected object is classified as a person on the basis of a main component analysis.
